(19) United States
(12) Patent Application Publication
(10) Pub. No.: US 2012/0141846 A1
(43) Pub. Date: Jun. 7, 2012

(54) LITHIUM SECONDARY BATTERY

(76) Inventors: Norio IWAYASU, Hitachinaka (JP); Jinbao Zhao, Xiamen (CN); Hidetoshi Honbo, Hitachinaka (JP)

(21) Appl. No.: 13/313,039

(22) Filed: Dec. 7, 2011

(30) Foreign Application Priority Data
Dec. 7, 2010 (JP) 2010-272121

(51) Int. Cl. H01M 10/42

(52) U.S. Cl. 429/61

(57) ABSTRACT

In a lithium secondary battery which contains an electrode group including a positive electrode, a negative electrode and a separator interposed between the positive electrode and the negative electrode, and an electrolytic solution, a current shut-off portion which is activated by an increase in an internal pressure is provided, a polymerizable compound having an aromatic functional group and a polymerizable functional group, or a polymer having an aromatic functional group and a residue of a polymerizable functional group is contained, and a carbon dioxide generating agent which produces carbon dioxide by a neutralization reaction is contained in at least one of the positive electrode and the separator. Thereby, the current shut-off valve is activated in an early stage of overcharge to increase the safety of the battery when overcharged.

### CLAIM OF PRIORITY

The present application claims priority from Japanese Patent application serial No. 2010-272121, filed on Dec. 7, 2010, the content of which is hereby incorporated by reference into this application.

### BACKGROUND OF THE INVENTION

1. Field of the Invention

The present invention relates to a lithium secondary battery.

2. Description of the Related Art

Since a lithium secondary battery has high energy density, and is therefore widely used in laptop computers, cellular phones and other devices, utilizing its characteristics. In recent years, an interest in electric vehicles has been increased from the perspective of preventing global warming caused by increased carbon dioxide, and application of the lithium secondary battery as power sources for the same has been studied.

Lithium secondary batteries also have problems although they have such excellent characteristics. One of the problems is improvement of safety. Especially, ensuring safety when they are overcharged is an important object.

In a state of being overcharged, the thermal stability of a lithium secondary battery may be lowered, which may lead to lowered safety of the same. Accordingly, various technical measures for preventing overcharge-related problems have been developed for currently used lithium secondary batteries.

Japanese Patent Application Laid-Open No. 2005-302727 discloses an electrochemical cell containing a cation selected from the group consisting of alkali metals, alkaline earth metals, tetraalkylammonium and an imidazolium group, and a salt including a borate cluster or heteroborate cluster anion.

Japanese Patent Application Laid-Open No. 2009-259604 discloses a technique pertaining to a lithium secondary battery including current shut-off mechanism operated by an increase in an internal pressure, in which lithium carbonate is disposed on the surface of a conductive material of a positive electrode.

Japanese Patent Application Laid-Open No. 2008-186792 discloses a technique pertaining to a non-aqueous electrolyte secondary battery including pressure-sensitive safety mechanism operated by an increase in an internal pressure of the battery, in which lithium carbonate is added to a positive electrode, and a cycloalkylbenzene compound and/or a compound having a quaternary carbon adjacent to a benzene ring is added to a non-aqueous electrolyte.

### SUMMARY OF THE INVENTION

In a lithium secondary battery of the present invention, a current shut-off portion which is activated by an increase in an internal pressure is provided; a polymerizable compound having an aromatic functional group and a polymerizable functional group, or a polymer having an aromatic functional group and residues of a polymerizable functional group is used as a constituent; and an agent (a carbon dioxide generating agent) which generates carbon dioxide by a neutralization reaction is contained in at least one of a positive electrode and a separator.

According to the present invention, the current shut-off valve can be activated in an early stage of overcharge, and therefore the safety of the battery can be improved.

### BRIEF DESCRIPTION OF THE DRAWINGS

FIG. 1 is a partial cross-sectional view showing a lithium secondary battery of an Example (a cylindrical lithium ion battery).

FIG. 2 is a perspective view showing a lithium secondary battery of an Example (a block-shaped lithium ion battery).

FIG. 3 is a cross-sectional view of FIG. 2 taken along line A-A.

FIG. 4 is a perspective cross-sectional view showing a secondary battery (a cylindrical lithium ion battery) of an Example.

### DETAILED DESCRIPTION OF THE PREFERRED EMBODIMENTS

Enhancing the safety of the overcharged battery is difficult only by improving a salt as in the electrochemical cell described in Japanese Patent Application Laid-Open No. 2005-302727.

Moreover, in the case of the technique described in Japanese Patent Application Laid-Open No. 2009-259604, lithium carbonate of the positive electrode generates carbon dioxide by electrolytic oxidation in an overcharged state, and a current shut-off valve is activated by increasing the internal pressure of the battery, whereby the overcharge is suppressed. However, the reaction potential of lithium carbonate is as high as 4.8 V to 5.0 V vs. Li/Li⁺, and a reaction starts in a late stage of overcharge. Therefore, problems related to the safety of overcharged batteries are left unsolved.

An object of the present invention is to activate a current shut-off valve in an early stage of the overcharge to increase the safety of the overcharged battery.

A lithium secondary battery according to an embodiment of the present invention will be described below.

The lithium secondary battery contains an electrode group including a positive electrode, a negative electrode and a separator nipped between the positive electrode and the negative electrode, and an electrolytic solution.

Herein, the positive electrode is formed by applying a positive electrode material to a current collector. Moreover, the negative electrode is formed by applying a negative electrode material to a current collector.

The lithium secondary battery has a current shut-off portion which is activated by an increase in an internal pressure, contains a polymerizable compound having an aromatic functional group and a polymerizable functional group, or a polymer having an aromatic functional group and residues of a polymerizable functional group, and at least one of the positive electrode and the separator contains an agent (a carbon dioxide generating agent) which generates carbon dioxide by a neutralization reaction.

In the lithium secondary battery, the polymerizable compound is represented by the following formula (1) or (2):

Z¹—X-A Chemical formula (1)

Z¹-A Chemical formula (2)

(wherein Z¹ is a polymerizable functional group; X is a hydrocarbon group or oxyalkylene group of C₁₋₂₀ (i.e., a hydrocarbon group or oxyalkylene group having carbon number of 1 to 20); A is an aromatic functional group.)

In the lithium secondary battery, the polymer is obtained by polymerizing the above-mentioned polymerizable compound.

In the lithium secondary battery, the polymer is represented by the following chemical formula (3) or (4).

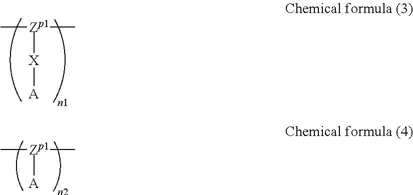

(wherein Z^{p1} is a residue of a polymerizable functional group; X is a hydrocarbon group or oxyalkylene group of C₁₋₂₀; A is an aromatic functional group. Subscripts “n1” and “n2” are each a positive integer.)

In other words, the polymerizable compound and the polymer contain a hydrocarbon group having carbon atoms of 1 to 20 or oxyalkylene group having carbon atoms of 1 to 20 in this specification.

In the lithium secondary battery, a polymerizable compound represented by the following chemical formula (5) is further contained.

Z²—Y Chemical formula (5)

(wherein Z² is a polymerizable functional group; and Y is a highly polar functional group.)

In the lithium secondary battery, a polymer obtained by allowing the polymerizable compound represented by the above chemical formula (1) or (2) and a polymerizable compound represented by the above chemical formula (5) to undergo copolymerization is contained.

In the lithium secondary battery, the polymer contains a repeat unit represented by the following chemical formula (6) or (7) .

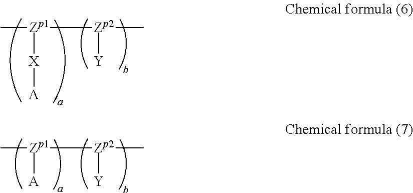

(wherein Z^{p1} and Z^{p2} are each a residue of a polymerizable functional group; X is a hydrocarbon group or oxyalkylene group of C₁₋₂₀; A is an aromatic functional group; Y is a highly polar functional group; and the ratio of a to b is equal to that of the number of Z^{p1} to Z^{p2}, which are residues of the polymerizable functional group.)

In the lithium secondary battery, the carbon dioxide generating agent is represented by AₓCO₃ or A_{y}HCO₃ (A is an alkali metal and alkaline earth metal. Subscript “x” is 2 when A is an alkali metal, while it is 1 when A is an alkaline earth metal. Subscript “y” is 1 when A is an alkali metal, while it is 0.5 when A is an alkaline earth metal.).

Regarding the carbon dioxide generating agent, from the perspective of achieving both of the performance and the safety of the battery, a preferably used carbon dioxide generating agent is AₓCO₃. Preferably used alkali metals and alkaline earth metals include Li, Na, K, Mg and Ca, among which Li and Na are especially preferable.

In the lithium secondary battery, the carbon dioxide generating agent is applied on a surface of the separator.

In the lithium secondary battery, the carbon dioxide generating agent is added to a positive electrode material containing a positive electrode active material which is a constituent of the positive electrode and a binder.

In the lithium secondary battery, the polymerizable compound or the polymer is contained in an electrolytic solution.

The lithium secondary battery desirably has a cylindrical outer configuration.

The carbon dioxide generating agent is desirably disposed on the positive electrode or separator, or on both the positive electrode and separator. When it is disposed on the positive electrode, the amount of the carbon dioxide generating agent introduced is 0 to 10 wt. % in a mixture (positive electrode material) containing the positive electrode active material, the conductive material and the binder which are constituents of the positive electrode. This amount introduced is preferably 0 to 5 wt. %. Herein, the amount introduced is a value determined based on a dry weight of the positive electrode material.

To introduce the carbon dioxide generating agent into the positive electrode, it is mixed into a slurry for producing the electrode, and then the electrode is produced by using the slurry. Moreover, to introduce the carbon dioxide generating agent into the separator, the carbon dioxide generating agent is dispersed in a solution of polyvinylidene difluoride (PVDF) in N-methyl-2-pyrrolidone (NMP solution), the solution is applied to the separator, and then NMP is removed.

In the above chemical formulae (1) and (2), Z¹ is a polymerizable functional group; X is a hydrocarbon group or oxyalkylene group of C₁₋₂₀; A is an aromatic functional group.

The polymerizable functional group is not particularly limited as long as it can undergo a polymerization reaction, but organic groups having an unsaturated double bond such as vinyl group, acryloyl group or methacryloyl group are preferably used.

Examples of C₁₋₂₀ hydrocarbon groups include aliphatic hydrocarbon groups such as methylene group, ethylene group, propylene group, isopropylene group, butylene group, isobutylene group, dimethyl ethylene group, pentylene group, hexylene group, heptylene group, octylene group, isooctylene group, decylene group, undecylene group, dodecylene group etc. and alicyclic hydrocarbon groups such as cyclohexylene group, dimethyl cyclohexylene group etc.

Examples of the oxyalkylene group include oxymethylene group, oxyethylene group, oxypropylene group, oxybutylene group and oxytetramethylene group.

The aromatic functional group is a functional group having 20 or less carbon atoms and satisfying the Huckel rule. Specific examples include cyclohexylbenzyl group, biphenyl group, phenyl group and a condensation product of the same, that is, naphthyl group, anthryl group, phenanthryl group, triphenylene group, pyrene group, chrysene group, naphthacene group, picene group, perylene group, pentaphene group, pentacene group and acenaphthylene group. Part of these aromatic functional groups may be replaced. Moreover, the aromatic functional group may contain elements other than carbon in its aromatic ring. The elements referred to herein are specifically S, N, Si, O and the like. From the perspective of electric stability, phenyl group, cyclohexylbenzyl group, biphenyl group, naphthyl group and anthracene group and tetracene group are preferable, and cyclohexylbenzyl group and biphenyl group are especially preferable.

When the battery is overcharged, the aromatic functional group in the polymer reacts to produce hydrogen ions. The reaction between the hydrogen ions and the carbon dioxide generating agent produces carbon dioxide, which activates a current shut-off valve (also referred to as a current shut-off portion.) in an early stage of overcharge to prevent the overcharge.

Z² in the above chemical formula (5) is a polymerizable functional group. The polymerizable functional group is not particularly limited as long as it can undergo a polymerization reaction, but organic groups having an unsaturated double bond such as vinyl group, acryloyl group and methacryloyl group are preferably used.

Y in the above chemical formulae (5), (6) and (7) is a highly polar functional group. Examples of the highly polar functional group include oxyalkylene group [(AO)ₘR], cyano group, amino group, hydroxyl group and thiol group. The affinity to the electrolytic solution can be increased by applying the highly polar functional group. A preferable oxyalkylene group is one in which AO is ethylene oxide and R is methyl, while m is 1 to 20, preferably 1 to 10, and especially preferably 1 to 5.

The term polymer means a compound obtained by allowing a polymerizable compound to undergo polymerization or by polymerizing the polymerizable compound.

In the present invention, both the polymerizable compound and the polymer can be used, but it is preferable from the perspective of the electrochemical stability to use a polymer prepared by allowing the polymerizable compound to undergo polymerization in advance to produce the polymer, followed by purification.

The polymerization may be performed by any of conventionally known bulk polymerization, solution polymerization and emulsion polymerization. Moreover, a preferable polymerization method used is a radical polymerization although it is not limited especially. In the polymerization, a polymerization initiator may be or may not be used, and a radical polymerization initiator is preferably used in terms of ease of handling. The polymerization method by using the radical polymerization initiator can be conducted in a temperature range and a polymerization time which are normally employed.

For the purpose of protecting components used in an electrochemical device, it is preferable to use a radical polymerization initiator having a 10 hour half-life temperature ranging from 30 to 90° C., which is an index of a decomposition temperature and rate. The term 10 hour half-life temperature used herein means a temperature required to decrease the amount of an undecomposed radical polymerization initiator at a concentration of 0.01 mol/L in a radical inert solvent such as benzene by ½ in 10 hours.

The amount of the polymerization initiator formulated is 0.1 to 20 parts by weight, and preferably 0.3 to 5 parts by weight, relative to 100 parts by weight of the polymerizable compound.

Examples of the radical polymerization initiator include t-butylperoxypivalate, t-hexyl peroxypivalate, methyl ethyl ketone peroxide, cyclohexanone peroxide, 1,1-bis(t-butylperoxy)-3′,3,5-trimethylcyclohexane, 2,2-bis(t-butylperoxy)octane, n-butyl-4,4-bis(t-butylperoxy)valerate, t-butyl hydroperoxide, cumene hydroperoxide, 2,5-dimethylhexane-2,5-dihydroperoxide, di-t-butyl peroxide, t-butyl cumyl peroxide, dicumyl peroxide, α,α′-bis(t-butylperoxy m-isopropyl)benzene, 2,5-dimethyl-2,5-di(t-butylperoxy)hexane, 2,5-dimethyl-2,5-di(t-butylperoxy)hexane, benzoyl peroxide, t-butylperoxypropyl carbonate and like organic peroxides, 2,2′-azobisisobutyronitrile, 2,2′-azobis(2-methylbutylonitrile), 2,2′-azobis(4-methoxy-2,4-dimethylvaloronitrile), 2,2′-azobis(2,4-dimethylvaleronitrile), 1,1′-azobis(cyclohexane-1-carbonitrile), 2-(carbamoylazo)isobutyronitrile, 2-phenylazo-4-methoxy-2,4-dimethyl-valeronitrile, 2,2-azobis(2-methyl-N-phenylpropionamidine)dihydrochloride, 2,2′-azobis[N-(4-chlorophenyl)-2-methylpropionamidine]dihydrochloride, 2,2′-azobis[N-hydroxyphenyl]-2-methylpropionamidine]dihydrochloride, 2,2′-azobis[2-methyl-N-(phenylmethyl)propionamidine]dihydrochloride, 2,2′-azobis[2-methyl-N-(2-propenyl)propionamidine]dihydrochloride, 2,2′-azobis(2-methylpropionamidine)dihydrochloride, 2,2′-azobis[N-(2-hydroxyethyl)-2-methylpropionamidine]dihydrochloride, 2,2′-azobis[2-(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl) propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin-2-yl) propane]dihydrochloride, 2,2′-azobis{2-[1-(2-hydroxyethyl)-2-imidazolin-2-yl]propane}dihydrochloride, 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis{2-methyl-N-[1,1-bis(hydroxymethyl)ethyl]propionamide}, 2,2′-azobis[2-methyl-N-(2-hydroxyethyl)propionamide], 2,2′-azobis(2-methylpropionamide)dihydrate, 2,2′-azobis(2,4,4-trimethylpentane), 2,2′-azobis(2-methylpropane), dimethyl, 2,2′-azobisisobutylate, 4,4′-azobis(4-cyanovaleric acid), 2,2′-azobis[2-(hydroxymethyl)propionitrile] and like azo compounds.

In the above chemical formulae (6) and (7), Z^{p1} and Z^{p2} are each a residue of a polymerizable functional group. The subscripted a and b are the ratios of constitutional units of Z^{p1} and Z^{p2}. A/(a+b) is 0 to 1. From the perspective of improving the affinity to the electrolytic solution, a/(a+b) is preferably 0.1 to 0.9, and particularly preferably 0.1 to 0.4.

The existence form of the polymerizable compound and polymer in the lithium secondary battery is not particularly limited, but the polymerizable compound and polymer is preferably used in coexistence with the electrolytic solution.

The polymerizable compound and polymer in the electrolytic solution may be in a state of being dissolved in the electrolytic solution (solution), or being suspended in the electrolytic solution.

The concentration (wt. %) of the polymerizable compound and polymer can be calculated by the following equation (1).

Concentration=(Weight of polymerizable compound and polymer)/{(Amount of electrolytic solution)+(Weight of polymerizable compound and polymer)}×100 Equation (1)

The range of this concentration is 0 to 100 wt. %, preferably 0.01 to 10 wt. %, and especially preferably 0.1 to 5 wt. %. The higher this value, the lower the ion conductivity of the electrolytic solution and the lower the battery performance. Moreover, the lower this value, the lower the effects of the present invention.

The number average molecular weight (Mn) of the polymer is 50000000 or lower, preferably 1000000 or lower, and further preferably 100000 or lower. A reduction in the battery performance can be suppressed by using the polymer having a low number average molecular weight.

The electrolytic solution is prepared by dissolving a supporting electrolyte in a nonaqueous solvent.

The nonaqueous solvent is not particularly limited as long as it dissolves a supporting electrolyte, but those named below are preferable: organic solvents such as diethyl carbonate, dimethyl carbonate, ethylene carbonate, ethyl methyl carbonate, propylene carbonate, γ-butyllactone, tetrahydrofuran and dimethoxyethane, which may be used singly or in combination. Moreover, a vinylene carbonate or vinyl ethylene carbonate having an unsaturated double bond in its molecule may be used.

The supporting electrolyte may be of any kind as long as it is soluble in a nonaqueous solvent, but those named below are preferable: electrolyte salts such as LiPF₆, LiN(CF₃SO₂)₂, LiN(C₂F₆SO₂)₂, LiClO₄.LiBF₄, LiAsF₆, LiI, LiBr, LiSCN, Li₂B₁₀Cl₁₀ and LiCF₃CO₂, which may be used singly or in combination.

The positive electrode active material is capable of occlude and release lithium ions, and is represented by formula LiMO₂ (M is a transition metal.). Examples include oxides having a layer structure such as LiCoO₂, LiNiO₂, LiMn_{1/3}Ni_{1/3}Co_{1/3}O₂ and LiMn_{0.4}Ni_{0.4}Co_{0.2}O₂, and oxides in which part of M is replaced by at least one metal element selected from the group consisting of Al, Mg, Mn, Fe, Co, Cu, Zn, Al, Ti, Ge, W and Zr. Moreover, oxides of Mn (manganese) having a spinel crystal structure such as LiMn₂O₄ and Li₁₊ₓMn₂₋ₓO₄ are also included. Furthermore, LiFePO₄ and LiMnPO₄ having an olivine structure may be also used.

Moreover, the negative electrode material used is a material produced by subjecting a graphitizable material obtained from natural graphite, petroleum coke, coal pitch coke and the like to a heat treatment at a high temperature of 2500° C. or higher, a mesophase carbon, an amorphous carbon, a carbon fiber and a metal which is capable of alloying with lithium, or a material produced by supporting a metal on surfaces of carbon particles. Examples include a metal selected from the group consisting of lithium, silver, aluminum, tin, silicon, indium, gallium and magnesium, or an alloy of them. Moreover, the metal or an oxide of the metal can be used as the negative electrode. In addition, titanium acid lithium may be also used.

The separator used may include one composed of a polymer such as polyolefin, polyamide and polyester, and a glass cloth composed of a fibrous glass fiber. Its raw material is not critical unless it adversely affects the lithium battery, but polyolefin is preferably used.

Examples of polyolefin include polyethylene and polypropylene, and a film formed by layering these materials may be used.

Moreover, the air permeability (sec/100 mL) of the separator is 10 to 1000, preferably 50 to 800, and particularly preferably 90 to 700.

The present invention will be described below more specifically with reference to Examples, but the present invention is not limited to these Examples.

<Method for Producing Electrodes>

<Positive Electrode>

Cellseed (lithium cobalt oxide manufactured by Nippon Chemical Industrial Co., Ltd.), SP270 (graphite manufactured by Nippon Graphite Industries, Ltd.) and KF1120 (polyvinylidene difluoride manufactured by Kureha Corporation) were mixed at a ratio of 85:10:10 by weight. The mixture was added to N-methyl-2-pyrrolidone and mixed, preparing a solution in the form of slurry. This slurry was applied by a doctor blade method onto an aluminum foil (current collector) having a thickness of 20 μm, and was dried. The amount of the mixture applied was 100 g/m².

<Negative Electrode>

An artificial graphite and polyvinylidene difluoride were mixed at a ratio of 90:10 by weight. The mixture was added to N-methyl-2-pyrrolidone, preparing a solution in the form of slurry. This slurry was applied by the doctor blade method onto a copper foil (current collector) having a thickness of 20 μm, and was dried. The amount of the mixture applied was 40 g/m². The thus-prepared copper foil was pressed so that the bulk density of the mixture was 1.0 g/cm³.

<Method for Producing 18650 Type Battery>

A separator was interposed between the positive electrode and the negative electrode, and was wound. The wound body was inserted into a 18650 battery can case. An electrolytic solution was then injected thereinto and the battery can case was sealed. Three cycles of charging and discharging were then repeated at a current value of 180 mA in a range of from 4.2 V to 3.0 V. The current value of discharge in the third cycle was determined as the capacity of the battery.

### <Method of Overcharge Test>

The produced battery was charged to 4.2 V in advance. The battery was then overcharged to 5.0 V at a current value of 600 mA. After the potential reached 5.0 V, the charging was continued at a constant potential of 5.0 V, and it was continued until the current value reached 60 mA.

### Example 1

A monomer (1) (0.3 mol, 73 g) represented by the following chemical formula (8) and a monomer (2) (0.7 mol, 132 g) represented by the following chemical formula (9) were mixed.

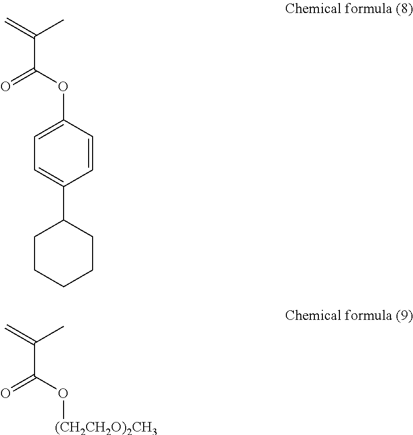

One part by weight of azobisisobutyronitrile (AIBN) was added as a polymerization initiator to 100 parts by weight of the total amount of monomer (1) and monomer (2). The reaction solution was then sealed, and was allowed to react over an oil bath at 60° C. for 3 hours. After the reaction was over, the reaction solution was added to 200 mL of methanol, giving white precipitates. The solution was then filtrated, was vacuum-dried at 60° C., thereby obtaining polymer A.

Polymer A was added to an electrolytic solution (electrolyte salt: LiPF₆, solvent: EC/DMC/EMC=1:1:1 (ratio by volume), electrolyte salt concentration: 1 mol/L) to attain a concentration of 3 wt. %. A battery was produced using this electrolytic solution. At this time, lithium carbonate (Li₂CO₃) was used as a carbon dioxide generating agent. This Li₂CO₃ was introduced into the positive electrode. The weight of Li₂CO₃ was adjusted to be 3 wt. % of the weight of the positive electrode material.

Next, the battery capacity was measured. As a result, the battery capacity was 1811 mAh.

An overcharge test was conducted using the battery. As a result, the voltage at which the current shut-off valve was activated was 4.5 V, and no burst or ignition of the battery was found.

### Example 2

A constitution similar to that in Example 1 was provided except that the disposition of lithium carbonate (Li₂CO₃) was the separator in Example 1. The amount of lithium carbonate was adjusted to be 3 wt. % of the weight of the positive electrode material.

Next, the battery capacity was measured. As a result, the battery capacity was 1820 mAh.

The overcharge test was conducted using the battery. As a result, the voltage at which the current shut-off valve was activated was 4.6 V, and no burst or ignition of the battery was found.

### Example 3

A constitution similar to that in Example 1 was provided except that lithium carbonate was disposed on the positive electrode and the separator in Example 1. The amount of lithium carbonate was set to be 3 wt. % of the weight of the positive electrode material, and was distributed in an amount of 1.5 wt. % to the positive electrode and the separator, respectively.

Next, the battery capacity was measured. As a result, the battery capacity was 1813 mAh.

The overcharge test was conducted using the battery. The voltage at which the current shut-off valve was activated was 4.6 V, and no burst or ignition of the battery was found.

### Example 4

Monomer (3) (0.3 mol, 67.2 g) represented by the following chemical formula (10) and the above-mentioned monomer (2) (0.7 mol, 132 g) were mixed.

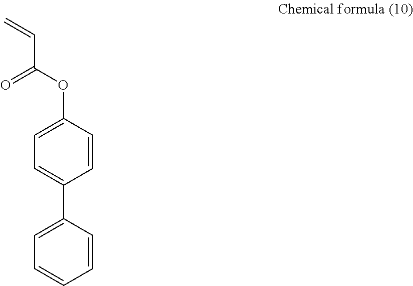

1 part by weight of AIBN was added to 100 parts by weight of the total amount of monomer (2) and monomer (3) as a polymerization initiator. The reaction solution was then sealed, and was allowed to react over an oil bath at 60° C. for 3 hours. After the reaction was over, the reaction solution was added to 200 mL of methanol, giving white precipitates. The solution was then filtrated and vacuum-dried at 60° C., obtaining polymer B.

Polymer B was added to an electrolytic solution (electrolyte salt: LiPF₆, solvent: EC/DMC/EMC=1:1:1 (ratio by volume), electrolyte salt concentration 1 mol/L) to attain a concentration of 3 wt. %.

A battery was produced using this electrolytic solution. At this time, Li₂CO₃ was used as a carbon dioxide generating agent. Li₂CO₃ was introduced into the positive electrode. Moreover, the weight of Li₂CO₃ was adjusted to be 3 wt. % of the weight of the positive electrode material.

Next, the battery capacity was measured. As a result, the battery capacity was 1809 mAh.

The overcharge test was conducted using the battery. As a result, the voltage at which the current shut-off valve was activated was 4.4 V, and no burst or ignition of the battery was found.

### Example 5

A battery was produced in a manner similar to that in Example 4 except that Na₂CO₃ was used in place of Li₂CO₃ in Example 4. The battery capacity of the produced battery was 1802 mAh.

The overcharge test was conducted using the battery. As a result, the voltage at which the current shut-off valve was activated was 4.4 V, and no burst or ignition of the battery was found.

### Example 6

A battery was produced in a manner similar to that in Example 4 except that NaHCO₃ was used in place of Li₂CO₃ in Example 4. The battery capacity of the produced battery was 1801 mAh.

The overcharge test was conducted using the battery. As a result, the voltage at which the current shut-off valve was activated was 4.4 V, and no burst or ignition of the battery was found.

### Comparative Example 1

A battery was produced in a manner similar to that in Example 1 except that Li₂CO₃ was not added in Example 1. The battery capacity of the produced battery was 1803 mAh.

The overcharge test was conducted using the battery. As a result, the current shut-off valve was not activated, and burst and ignition of the battery were found.

### Comparative Example 2

A battery was produced in a manner similar to that in Example 1 except that polymer A was not added in Example 1. The battery capacity of the produced battery was 1801 mAh.

The overcharge test was conducted using the battery. As a result, the current shut-off valve was activated at 4.9 V, but the battery then bursted.

### Comparative Example 3

A battery was produced in a manner similar to that in Comparative Example 2 except that Na₂CO₃ was used in place of Li₂CO₃ in Comparative Example 2. The battery capacity of the produced battery was 1802 mAh.

The overcharge test was conducted using the battery. As a result, the current shut-off valve was not activated, and burst and ignition of the battery were found.

Table 1 shows the results of Examples and Comparative Examples.

TABLE 1

| | | | | | Concentration of | | | | | |
|---|---|---|---|---|---|---|---|---|---|---|
| | | | | | carbon dioxide | | | Battery voltage | | |
| | | | Carbon | | generating agent | | Activation | at which | | |
| | | Concentration | dioxide | Disposition of | (vs. positive | Battery | of current | current | | |
| | Name of | of polymer | generating | carbon dioxide | electrode material, | capacity | shut-off | shut-off valve | | |
| | polymer | (wt. %) | agent | generating agent | wt. %) | (mAh) | valve | activated (V) | Burst | Ignition |
| Example 1 | Polymer A | 3 | Li₂CO₃ | Positive electrode | 3 | 1811 | Yes | 4.5 | No | No |
| Example 2 | Polymer A | 3 | Li₂CO₃ | Separator | 3 | 1820 | Yes | 4.6 | No | No |
| Example 3 | Polymer A | 3 | Li₂CO₃ | Positive electrode, | 3 | 1813 | Yes | 4.6 | No | No |
| | | | | separator | | | | | | |
| Example 4 | Polymer B | 3 | Li₂CO₃ | Positive electrode | 3 | 1809 | Yes | 4.4 | No | No |
| Example 5 | Polymer B | 3 | Na₂CO₃ | Positive electrode | 3 | 1802 | Yes | 4.4 | No | No |
| Example 6 | Polymer B | 3 | NaHCO₃ | Positive electrode | 3 | 1801 | Yes | 4.4 | No | No |
| Comp. | — | — | — | — | — | 1803 | No | — | Yes | Yes |
| Example 1 | | | | | | | | | | |
| Comp. | — | — | Li₂CO₃ | Positive electrode | 3 | 1801 | Yes | 4.9 | Yes | No |
| Example 2 | | | | | | | | | | |
| Comp. | — | — | Na₂CO₃ | Positive electrode | 3 | 1802 | Yes | 4.9 | Yes | Yes |
| Example 3 | | | | | | | | | | |

It can be seen from this table that in Examples 1 to 6, the electrolytic solution contains polymer A or polymer B; the activation of the current shut-off valve was observed; the battery voltages at the time of activation of the current shut-off valve are 4.4 to 4.6 V; and no burst or ignition of the batteries was found. On the other hand, in Comparative Examples 1 to 3, the electrolytic solution contains no polymer; the battery voltage at the time of activation of the current shut-off valve was 4.9 V; and burst of the battery was found.

The constitution of the lithium secondary battery of Examples will be described below with reference to drawings.

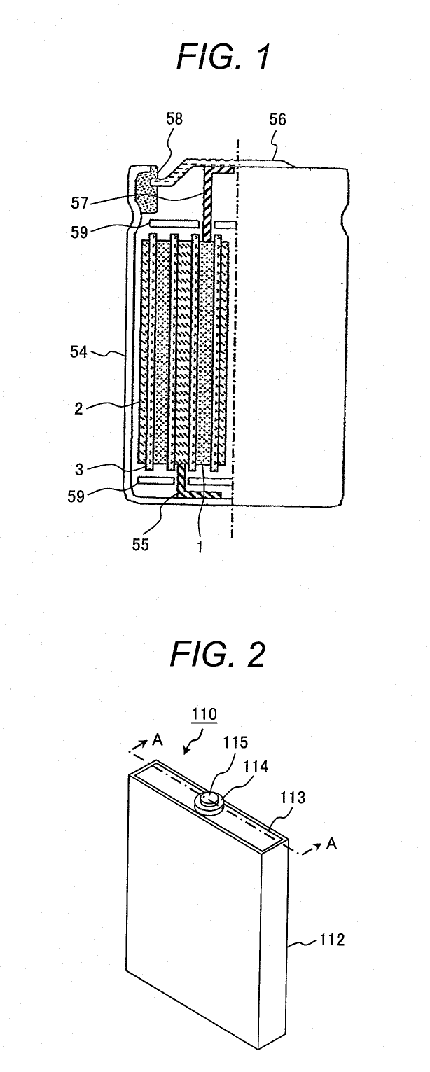

FIG. 1 is a partial cross-sectional view showing a lithium secondary battery (a cylindrical lithium ion battery).

A positive electrode 1 and a negative electrode 2 are wound cylindrically with a separator 3 interposed therebetween so that these electrodes do not come into a direct contact, and constitute an electrode group. A positive electrode lead 57 is attached to the positive electrode 1, while a negative electrode lead 55 is attached to the negative electrode 2.

The electrode group is inserted into a battery can case 54. Insulating plates 59 are placed at the bottom and top of the battery can case 54, respectively, so that the electrode group does not come into a direct contact with the battery can case 54. An electrolytic solution is injected into the battery can case 54.

The battery can case 54 is sealed in a state of being insulated from a lid portion 56 via a parking 58.

FIG. 2 is a perspective view showing a secondary battery (a block battery) of Examples.

In this figure, a battery 110 (a nonaqueous electrolytic solution secondary battery) is configured by a flat-shaped wound electrode body sealed together with a nonaqueous electrolytic solution in a block-shaped can case 112. A terminal 115 is provided at a center of a lid plate 113 via an insulator 114.

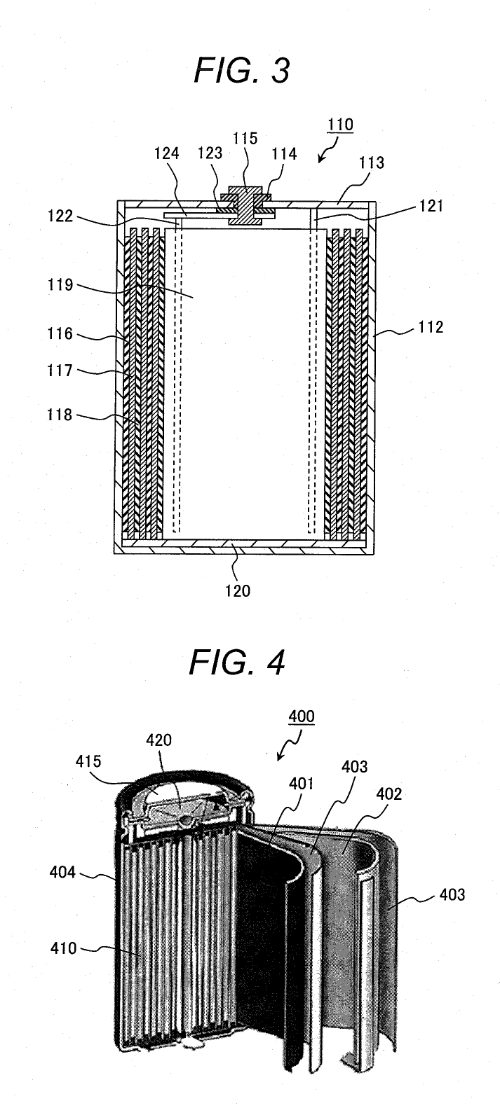

FIG. 3 is a cross-sectional view of FIG. 2 taken along line A-A.

In this figure, a positive electrode 116 and a negative electrode 118 are wound in a manner of interposing a separator 117, and constitute a flat-shaped wound electrode body 119. An insulator 120 is provided at a bottom of a can case 112 so that the positive electrode 116 and the negative electrode 118 do not short-circuit.

The positive electrode 116 is connected to the lid plate 113 via a positive electrode lead body 121. In contrast, the negative electrode 118 is connected to the terminal 115 via a negative electrode lead body 122 and a lead plate 124. An insulator 123 is interposed between the lead plate 124 and the lid plate 113 so that they do not come into a direct contact.

The constitutions of the secondary batteries according to Examples described above are mere examples. The secondary battery of the present invention is not limited to these examples, and includes any batteries employing the above-mentioned positive electrode, separator and electrolytic solution.

FIG. 4 is a perspective cross-sectional view showing a secondary battery (a cylindrical lithium ion battery) of an Example.

In a cylindrical lithium ion battery 400 of this figure, a positive electrode 401 and a negative electrode 402 are wound cylindrically with a separator 403 interposed therebetween so that these electrodes do not come into a direct contact, and constitute an electrode group 410.

The electrode group 410 is inserted into a battery can case 404. A current shut-off valve 420 is placed at a top of the battery can case 404. An electrolytic solution is injected into the battery can case 404.

The battery can case 404 is sealed in a state of being insulated from a lid portion 415 via a packing.

The current shut-off valve 420 is activated by an increase in an internal pressure. Thereby, the safety of the battery 400 can be kept.

What is claimed is:

1. A lithium secondary battery comprising:
an electrode group including a positive electrode, a negative electrode and a separator interposed between the positive electrode and the negative electrode; and
an electrolytic solution,
having a current shut-off portion which is activated by an increase in an internal pressure,
including a polymerizable compound having an aromatic functional group and a polymerizable functional group, or a polymer having an aromatic functional group and a residue of a polymerizable functional group,
wherein at least one of the positive electrode and the separator contains a carbon dioxide generating agent which generates carbon dioxide by a neutralization reaction.

2. The lithium secondary battery according to claim 1,
wherein the polymerizable compound is represented by the following formula (1) or (2):
Z¹—X-A Chemical formula (1)
Z¹-A Chemical formula (2)
(wherein Z¹ is a polymerizable functional group; X is a hydrocarbon group or an oxyalkylene group having carbon number of 1 to 20; and A is an aromatic functional group.)

3. The lithium secondary battery according to claim 2,
wherein the polymer is obtained by polymerizing the polymerizable compound.

4. The lithium secondary battery according to claim 1,
wherein the polymer is represented by the following chemical formula (3) or (4). 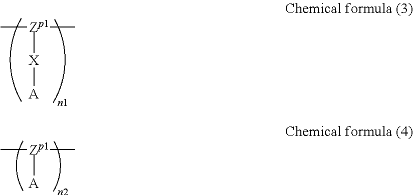
(wherein Z^{p1} is a residue of a polymerizable functional group: X is a hydrocarbon group or an oxyalkylene group having carbon number of 1 to 20; A is an aromatic functional group; and subscripts “n1” and “n2” are each a positive integer.)

5. The lithium secondary battery according to claim 2,
wherein a polymerizable compound represented by the following chemical formula (5) is further contained.
Z²—Y Chemical formula (5)
(wherein Z² is a polymerizable functional group; and Y is a highly polar functional group.)

6. The lithium secondary battery according to claim 5,
wherein a polymer obtained by allowing a polymerizable compound represented by the chemical formula (1) or (2) and a polymerizable compound represented by the chemical formula (5) to undergo copolymerization is contained.

7. The lithium secondary battery according to claim 1,
wherein the polymer contains a repeat unit represented by the following chemical formula (6) or (7). 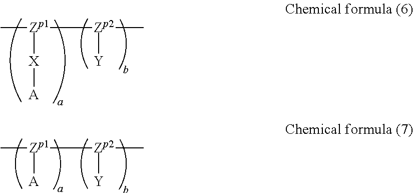
(wherein Z^{p1} and Z^{p2} are each a residue of a polymerizable functional X is a hydrocarbon group or an oxyalkylene group having carbon number of 1 to 20; A is an aromatic functional group; Y is a highly polar functional group; and the ratio of a to b is equal to that of the number of Z^{p1} to Z^{p2}.)

8. The lithium secondary battery according to claim 1, wherein the carbon dioxide generating agent is represented by AₓCO₃ or A_{y}HCO₃ (A is an alkali metal and alkaline earth metal; subscript “x” is 2 when A is an alkali metal, while it is 1 when A is an alkaline earth metal; and subscript “y” is 1 when A is an alkali metal, while it is 0.5 when A is an alkaline earth metal.).

9. The lithium secondary battery according to claim 1,
wherein the carbon dioxide generating agent is applied onto a surface of the separator.

10. The lithium secondary battery according to claim 1,
wherein the carbon dioxide generating agent is added to a positive electrode material containing a positive electrode active material and a binder being constituents of the positive electrode.

11. The lithium secondary battery according to claim 1,
wherein the polymerizable compound or the polymer is contained in the electrolytic solution.

12. The lithium secondary battery according to claim 1,
having a cylindrical outer configuration.
